(19) United States
(12) Patent Application Publication
(10) Pub. No.: US 2012/0017867 A1
(43) Pub. Date: Jan. 26, 2012

(54) INCREASE TORQUE OUTPUT FROM RECIPROCATING PISTON ENGINE

(76) Inventor: Hendrikus Johan Swienink, Oregon City, OR (US)

(21) Appl. No.: 13/258,343

(22) PCT Filed: Feb. 16, 2010
(86) PCT No.: PCT/US10/00438

§ 371 Date: Sep. 21, 2011

Related U.S. Application Data
(63) Continuation of application No. 12/386,229, filed on Apr. 15, 2009, now abandoned.

(51) Int. Cl. F02B 75/32; F16C 3/04

(52) U.S. Cl. 123/197.4; 74/595

(57) ABSTRACT

Reciprocating powered driven engine having a piston with multiplier connecting rods, driving multiplier crankshafts. Maximum crankshaft torque output positioned closer to the detonation timing and piston “top dead center” when cylinder above piston volume is at a lower value. Reduced engine friction losses by canceling piston side forces with the use of multiplier crankshafts positioned in offset and mirror image from piston and cylinder center line.

### FEDERALLY SPONSORED RESEARCH

Not applicable

### SEQUENCE LISTING OR PROGRAM

Not applicable

### BACKGROUND FIELD

This application relates to increase torque output from reciprocating driven piston engine.

### BACKGROUND

### Prior Art

Most present in use (prior art) reciprocating driven piston type engines are of a symmetrical layout.

At a symmetrical engine {prior art) the cylinder and piston center line passes through the crankshaft pivot center of rotation see FIG. 1

The torque output of a this type engine layout is minimum at piston top position when connecting rod from piston to crankshaft is in line with cylinder center. This position is called “top dead center” and the crankshaft position is called at “zero” degrees.

The cylinder volume above piston is minimum at the start of the power stroke and gasses are maximum compressed. As detonation of the gasses follows and the pressure increased, the piston is driven downwards, rotating the crankshaft over 180 degrees to the piston lower position, called “bottom dead center”. The torque output of the crankshaft of a symmetrical layout engine (prior art) is zero at “top and bottom” position and maximum when close to 90 degrees of crankshaft rotation at the power stroke with maximum piston side force, see FIG. 2. See torque output curve (prior art) FIG. 3.

The above piston pressure changes are shown in a pressure curve layout see FIG. 4. The bottom line shows the crankshaft rotation in degrees, the vertical line shows the pressure above the piston.

This being maximum right after detonation of the fuel gasses close after piston “top dead center” as the piston travel downwards, than pressure above piston decreased due to expansion of space and cooling from the increasing exposed cylinder wall area. This curve shown here is one example of many variations possible due to detonation timing, the use of different fuels and engine layout design

As piston travels about halve down the cylinder and crankshaft turn to the maximum torque output position, the pressure above piston is at a reduced value. After piston travels further down the cylinder to a full downward stroke and crankshaft rotated to 180 degrees (a halve crankshaft rotation) the pressure drop off, the exhaust valve opens and discharging the burned gasses. At FIG. 5 is shown the two curves of FIG. 3 and FIG. 4 superimposed in relation to the crankshaft angle of rotation in degrees.

This revealed that the full pressure created by the detonation of the fuel above the piston is not in synchronous with maximum crankshaft torque output position and therefore lower the effectiveness of the engine torque output

A second reduction of torque output at a symmetrical type engine (prior art) is due to the friction between piston rings and cylinder wall. As piston move downwards the cylinder housing, the piston connecting rod to the crankshaft is moving outwards, away from the cylinder and piston center line. This created a side force to the piston, pushing the piston rings against the cylinder wall, increase friction losses. This. force is maximum at the power cycle as the crankshaft is close at 90 degrees, at the maximum leverage arm output position. See FIG. 2. This affects the piston rings, compressing it on one side and expanding at the opposite side from piston center The same occurs in reverse when piston travels past 180 degrees upwards to full crankshaft 360 degrees rotation.

This compromise over time the sealing function of the piston rings due to wear and reducing compression as clearance increase between piston rings and cylinder wall, lowering the engine torque output.

Also lubrication oil between piston and cylinder wall enter the above piston cylinder area, burning with the hot gasses, called “piston blow by” This “piston blow by” add to exhaust pollution over the lifespan of the engine as clearance tolerances increased due to friction wear to cylinder wall and piston ring diameters

### SUMMARY

(a) With offset locating crankshaft pivot center from the cylinder centerline, the maximum lever arm of the crankshaft position has moved closer to the detonation timing when cylinder above piston volume is at a lower value.

(b) Reduce piston to cylinder wall friction by cancel out piston side forces with counter rotating crankshafts, positioned in mirror image to each other from the cylinder and piston centerline

### DRAWINGS—FIGURES

FIG. 1 shows at a symmetrical engine (prior art} the piston and cylinder center line passes thru the crankshaft pivot center of rotation.

FIG. 2 shows maximum piston side force of a symmetrical engine (prior art).

FIG. 3 shows the torque output curve of a symmetrical position engine (prior art) at the power stroke.

FIG. 4 shows the above piston pressure changes of gas and diesel engines related to crankshaft rotation callout in degrees.

FIG. 5. shows the two curves from FIG. 3 and FIG. 4 superimposed in relation to crankshaft angle of rotation, callout in degrees.

FIG. 6 shows the difference in torque output of a symmetrical engine (prior art) and this embodiment multiplier crankshaft engine in relation to crankshaft rotation angles.

FIGS. 7a and 7b shows the difference features in perspective view between this embodiment in relation to a symmetrical engine (prior art) at a crankshaft position of ten degrees past “top dead center”.

FIGS. 8a and 8b shows the difference features in perspective view between this embodiment in relation to a symmetrical engine (prior art) at a crankshaft position of ten degrees past “bottom dead center”

FIGS. 9a an 9b shows the different piston and crankshaft angle positions at “top dead center” with similar crankshaft, piston, connecting rod and crankshaft sizes between a symmetrical engine (prior art} and this embodiment multiplier crankshaft engine.

FIGS. 10a,10b,11a,and 11b shows the different positions of the pistons with similar crankshaft, piston, connecting rod and crankshaft sizes with the same crankshaft angle of rotation between a symmetrical engine (prior art) and this embodiment multiplier crankshaft engine.

FIGS. 12a and 12b shows the different piston and crankshaft angle positions at “bottom dead center” with similar crankshaft, piston, connecting rod and crankshaft sizes between a symmetrical engine (prior art) and this embodiment multiplier crankshaft engine.

FIG. 13 shows the piston velocity of a symmetrical engine (prior art) and this embodiment multiplier crankshaft engine in relation to crankshaft rotation in 15 degrees intervals over 360 degrees a full crankshaft rotation at constant revolution speed.

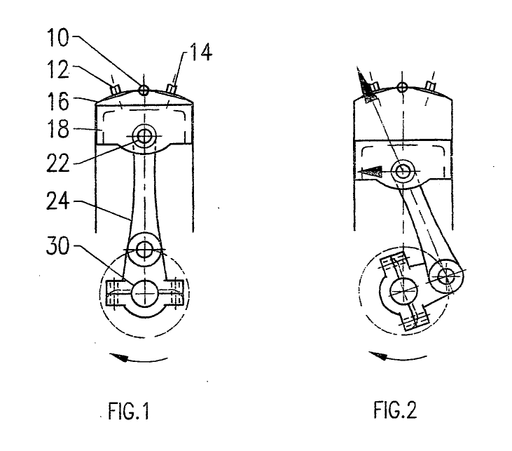

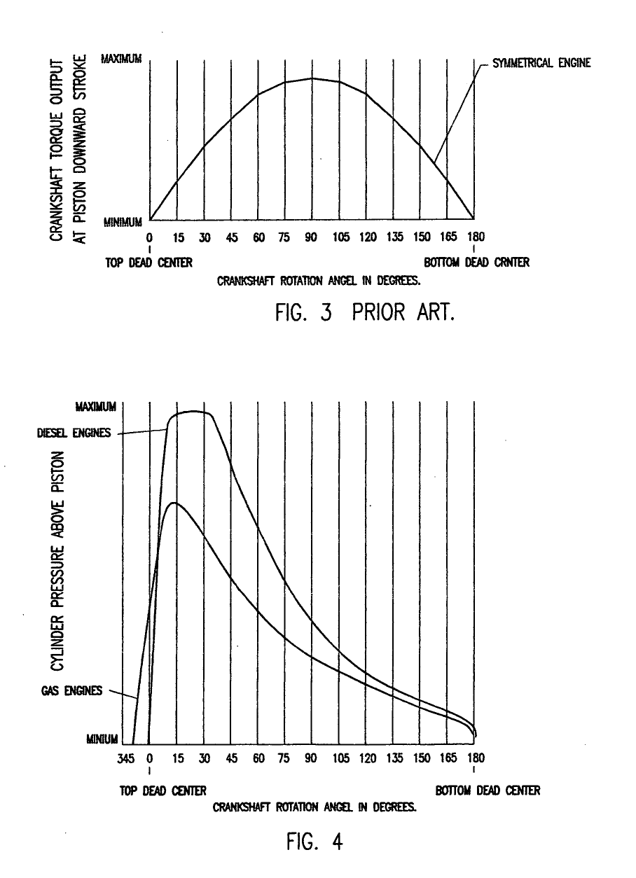

### DRAWINGS—REFERENCE NUMERALS

10 sparkplug or glow plug
12 air or gas inlet valve
14 exhaust valve.
16 cylinder housing.
18 piston.
20 piston seal and greasing rings.
22 piston to connecting rod pivot pin.
24 connecting rod with journal bearing.
26 counter rotating crankshafts with rotational energy connecting elements and flywheel.
28 crankshaft support bearings.
30 crankshaft (prior art) of an symmetrical type engine with flywheel connection

### DETAILED DESCRIPTION

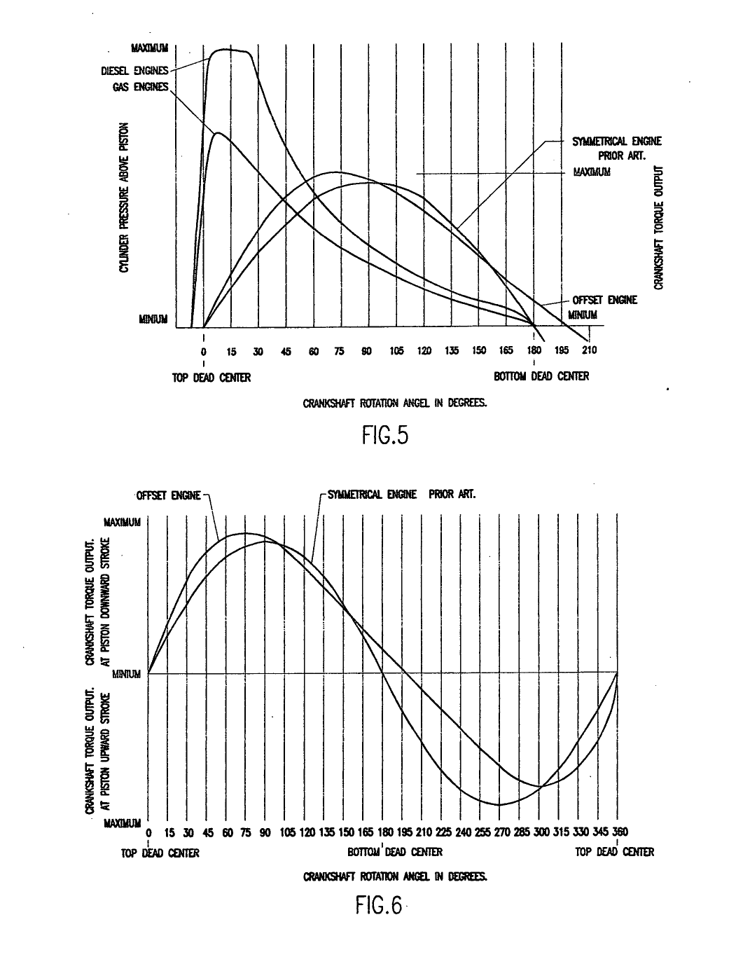

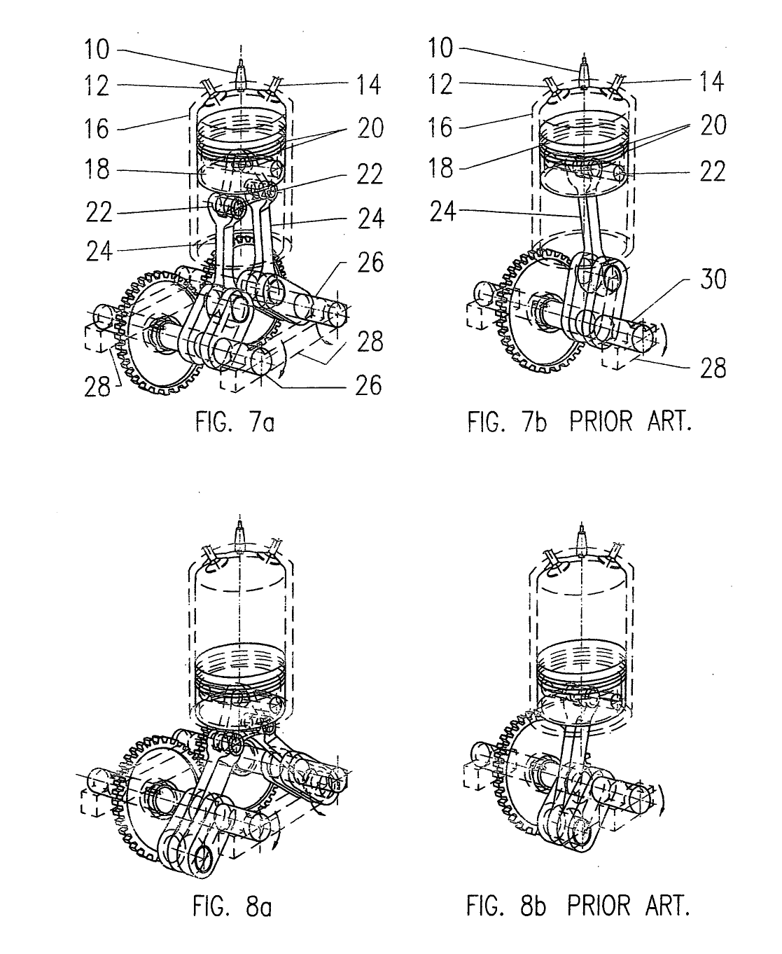

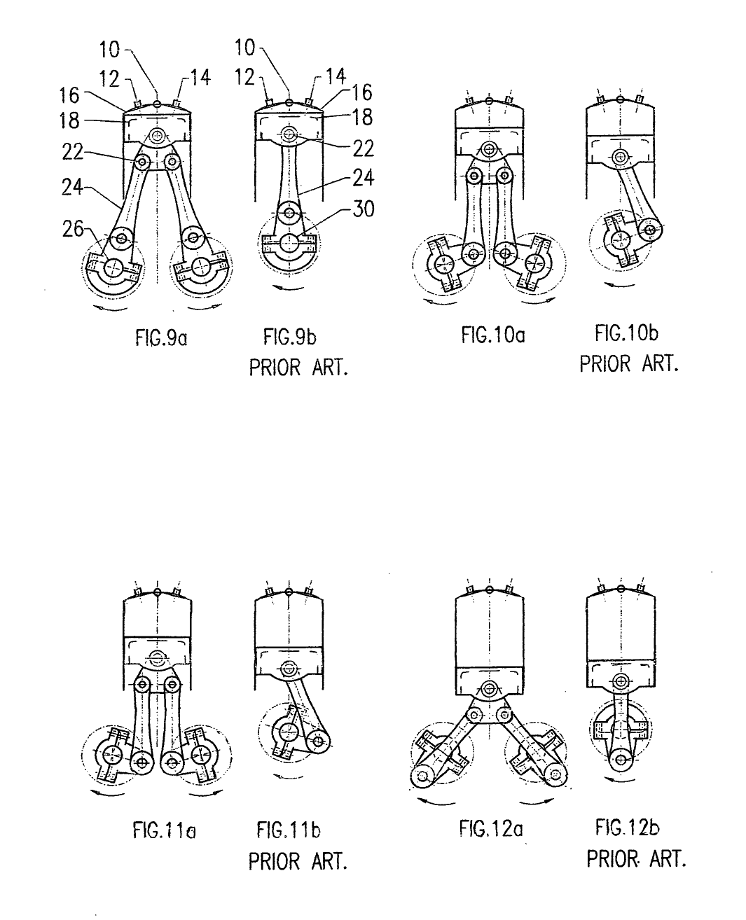

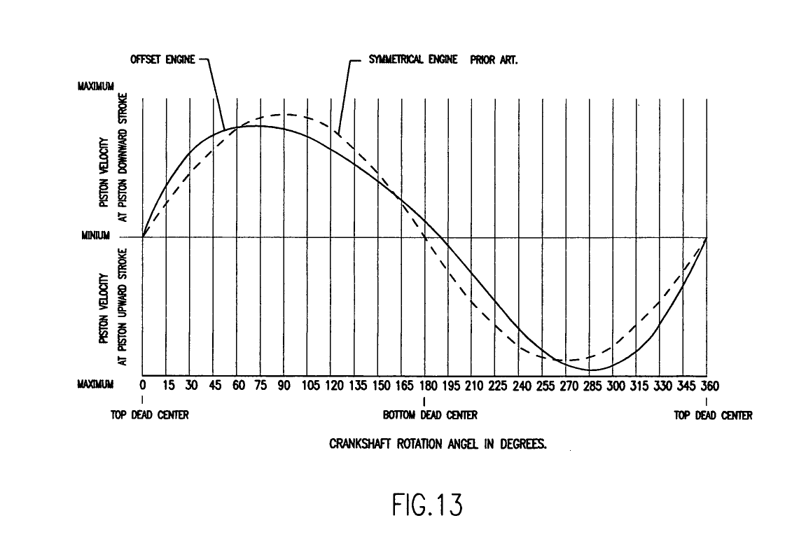

### FIG. 6, FIG. 7a, FIG. 8a and FIG. 13. The Embodiment

By moving the crankshaft center in a offset location from cylinder and piston centerline, the maximum crankshaft leverage position has moved closer to detonation timing and piston “top dead center”. The torque curve of an offset crankshaft in that position is shown at FIG. 6.

Also shown here is the curve from a symmetrical layout engine (prior art) to compare the difference positions of maximum torque output between the two type engines in relation to the crankshaft angle of rotation.

At a symmetrical engine (prior art) each of the piston up and down strokes are 180 degrees of the crankshaft rotation. Due to the offset used in this embodiment, the downward cycle time has increased and the upwards cycle time decreased by the same amount, total to 360 degrees of one rotation of the crankshaft. This different amount is depending on the piston stroke, the offset location and length of connecting rod and the crankshaft dimensions. With constant crankshaft rotation, at a four cycle engine layout, the air or gasses intake and power cycle, the piston velocity is reduced. At the compression and exhaust cycle, the piston velocity increased.

The offset crankshaft position layout also creates an increase to the side force to the piston as it move up and down the cylinder housing.

To neutralize this force, a second with similar overall dimensions crankshaft and connecting rod layout is located in mirror image placed on the opposite side of the cylinder and piston centerline.

See FIG. 7a and FIG. 8a

Both crankshafts are connected to the same piston but rotating in opposite directions.

Both are coupled and synchronized with rotational energy connecting elements, like gears, time belts, etc, The piston site forces are now opposite to each other and canceling it to zero. The downwards piston forces are also evenly divided between the connecting rods, crankshafts, piston pins and shaft bearings. Their bending and torque capabilities and the bearings sizes can be reduced due to the lower loadings. The piston travels straight up and down without any side forces at all functions and positions of the engine cycles. This lowers the overall friction losses of the engine, adding torque output.

Piston velocity at down cycle with the offset crankshaft position has decreased and the upwards piston cycle has increased with an amount depending on engine layout. see FIG. 13.

Although the description above contains many specifities, these should not be construed as limiting the scope of the embodiment but as merely providing illustrations of some of the presently preferred embodiments. For example, the piston, connecting rod and crankshaft can have other positions or relations to each other to obtain different margin of results. This the scope of the embodiments should be determined by the appended claims and their legal equivalents, rather than by the example given.

I claim:

1. Reciprocating powered driven piston engines comprising of pistons having multiplier connecting rods pin attachments per piston.

2. Multiplier crankshafts located off center on each side in mirror image from piston and cylinder center line.

3. Each crankshaft are connected to the same piston with connecting rods

4. Crankshafts are coupled and synchronized with rotational energy connecting elements to provide combined rotational energy output
